(19) United States
(12) Patent Application Publication
(10) Pub. No.: US 2014/0160231 A1
(43) Pub. Date: Jun. 12, 2014

(54) MULTI-FOCAL IMAGE CAPTURE AND DISPLAY

(71) Applicants: DANIEL C. MIDDLETON, Independence, MN (US); ROBERT L. VAUGHN, Albuquerque, NM (US); LANCE R. ATENCIO, Albuquerque, NM (US)

(72) Inventors: DANIEL C. MIDDLETON, Independence, MN (US); ROBERT L. VAUGHN, Albuquerque, NM (US); LANCE R. ATENCIO, Albuquerque, NM (US)

(21) Appl. No.: 13/712,692

(22) Filed: Dec. 12, 2012

(51) Int. Cl. H04N 5/232

(52) U.S. Cl. CPC H04N 5/23238
USPC 348/36

(57) ABSTRACT

Various embodiments are directed to using two or more image sensors in tandem, one configured with a narrower field of view that overlaps a portion of a wider field of view of another. An device includes a first image sensor to capture a first image of a scene with a first field of view, a second image sensor to capture a second image of the scene with a second narrower and substantially overlapping field of view, a processor circuit and a storage storing instructions causing the processor circuit to operate the first image sensor to capture a first image of the scene, and operate the second image sensor substantially in unison with the first image sensor to capture a second image of the scene that overlaps the first image. Other embodiments are described and claimed herein.

### BACKGROUND

The increasing prevalence of relatively low cost digital cameras made possible through the use of relatively low cost image sensors (e.g., charge-coupled devices or CCDs) has brought many benefits. Digitally captured images are able to be more easily stored, copied, provided to others, manipulated in various useful ways, and incorporated into larger and more complex imagery. However, the resulting tendency of many to now view captured images via computing devices has brought about unrealistic expectations of flexibility in the viewing of those images.

Specifically, unrealistic expectations have developed over time in the degree to which a viewer of an image is able to “zoom in” on a particular part of that image in order to see more detail. These unrealistic expectations partly derive from a lack of understanding that so-called “zooming in” on a portion of a digital image is, in truth, little more than scaling up the size of the pixels of that portion of the image. Such scaling up of pixels may make those pixels easier to see, but does not reveal any more detail than was originally recorded at the time the image was captured. Thus, paradoxically, “zooming in” on a portion of a digital image actually brings about a reduction in the visual information that is visually presented, since it ultimately results in the limited viewing space of a display showing fewer pixels than before. These unrealistic expectations also partly derive from technically inaccurate television and movie portrayals of what can be accomplished by image processing technologies (sometimes referred to as the “CSI effect”).

One approach to enabling better results from zooming into a portion of an image would be to generally increase the pixel density of captured images through use of higher resolution image sensors. However, use of such higher resolution image sensors is often cost prohibitive, as the resulting digital camera tends to be priced far higher than what many consumers are willing pay. Indeed, costs can rise higher still if using a higher resolution image sensor that is also larger to capture higher resolution imagery across a wider field of view. It is with respect to these and other considerations that the embodiments described herein are needed.

### BRIEF DESCRIPTION OF THE DRAWINGS

FIG. 1 illustrate different portions of a first embodiment of interaction among computing devices.

FIG. 2 illustrates an aspect of image capture of a first implementation of the embodiment of FIG. 1.

FIGS. 3a and 3b illustrate aspects of image capture of a second implementation of the embodiment of FIG. 1.

FIG. 4 illustrates an aspect of image merging of the embodiment of FIG. 1.

FIG. 5 illustrates a portion of the embodiment of FIG. 1.

FIG. 6 illustrates a portion of the embodiment of FIG. 1.

FIG. 7 illustrates an embodiment of a first logic flow.

FIG. 8 illustrates an embodiment of a second logic flow.

FIG. 9 illustrates an embodiment of a third logic flow.

FIG. 10 illustrates an embodiment of a fourth logic flow.

FIG. 11 illustrates an embodiment of a fifth logic flow.

FIG. 12 illustrates an embodiment of a processing architecture.

### DETAILED DESCRIPTION

Various embodiments are generally directed to the use of two or more lower cost image sensors in tandem in a capture assembly in a digital camera where at least one of the image sensors is configured to capture an image in a narrower field of view that overlaps a portion of what is captured by at least one other of the image sensors in a wider field of view. More specifically, different image sensors in a capture assembly of at least two image sensors are positioned relative to each other and provided with different optics that provide different fields of view that at least substantially (if not entirely) overlap to enable at least a substantial portion of the image captured in a wider field of view to also be captured in a narrower field of view. As a result, this portion of the image captured in the wider field of view is also captured in the narrower field of view with a greater density of pixels enabling better results when zooming into that portion during viewing.

A digital camera equipped with such a capture assembly may merge the different fields of view into a single image, replacing a portion of an image captured in the wider field of view by one image sensor with an overlapping image captured in a narrower field of view by another image sensor, resulting in an image in which different portions are made up of pixels of different densities. The resulting merged image may then be compressed using any of a variety of known techniques, and then stored and/or transmitted to another device for later viewing. During such viewing, the one or more portions having a higher pixel density would be more capable of satisfying the desire to provide greater detail should a viewer operate a viewing device to zoom into that portion.

It is envisioned that, at least in some embodiments, at least one portion of an image having a higher pixel density would be positioned at or about the center of that image in recognition of the human tendency to attempt to center the field of view of an image on the object or person of greatest interest to them at the time they operated a camera to capture an image. Thus, such embodiments, a presumption is made that someone viewing the wider image will be more likely to zoom in towards the center of that image than towards a portion about one of the edges of that image.

As an alternative to merging the different captured images of wider and narrower fields of view within the digital camera, those captured wider and narrower field of view images may be stored as still separate images, possibly along with data conveying various parameters of the capture assembly to better enable another computing device (e.g., a viewing device) to merge them at a later time. Regardless of which computing device merges the separate captured images, various techniques may be employed, including techniques employing algorithms to match objects depicted in each of the images (often referred to as “feature matching”) and/or techniques using information concerning characteristics of the capture assembly (e.g., intrinsic characteristics of the image sensors and/or optics, or extrinsic characteristics of the manner in which they are positioned and oriented relative to each other) to determine the manner in which the separate captured images overlap.

In one embodiment, for example, an device includes a first image sensor to capture a first image of a scene with a first field of view; a second image sensor to capture a second image of the scene with a second field of view that is narrower than and substantially overlaps the first field of view; a processor circuit and a storage communicatively coupled to the processor circuit to store instructions that when executed by the processor circuit cause the processor circuit to operate the first image sensor to capture a first image of the scene; and operate the second image sensor substantially in unison with the first image sensor to capture a second image of the scene that overlaps the first image. Other embodiments are described and claimed herein.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may incorporate a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

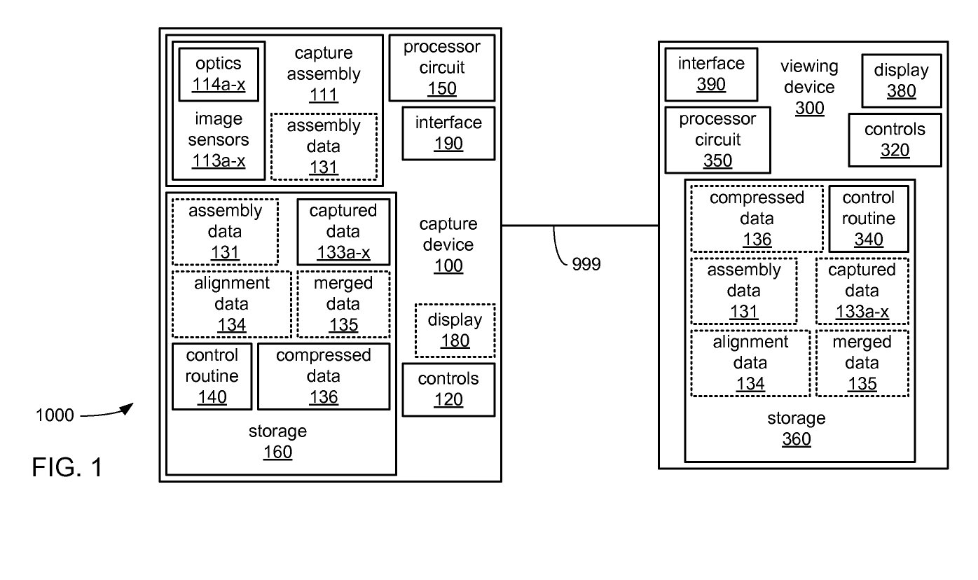

FIG. 1 depicts a block diagram of interactions among computing devices of an image handling system 1000 comprising a capture device 100 to capture an image and a viewing device 300 to view the image. Each of these computing devices 100 and 300 may be any of a variety of types of computing device, including without limitation, a desktop computer system, a data entry terminal, a laptop computer, a netbook computer, an ultrabook computer, a tablet computer, a handheld personal data assistant, a smartphone, a digital camera, a mobile device, a body-worn computing device incorporated into clothing, a computing device integrated into a vehicle, a server, a cluster of servers, a server farm, etc.

As depicted, these computing devices 100 and 300 exchange signals conveying captured and/or merged images, compressed or not compressed, along with data specifying characteristics of components employed in capturing those images through a network 999. However, one or more of these computing devices may exchange other data entirely unrelated to images or the capturing of images. In various embodiments, the network 999 may be a single network possibly limited to extending within a single building or other relatively limited area, a combination of connected networks possibly extending a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the capture device 100 incorporates one or more of a processor circuit 150, a storage 160, controls 120, a display 180, a capture assembly 111, and an interface 190 coupling the capture device 100 to the network 999. The storage 160 stores one or more of a control routine 140, assembly data 131, captured data 133a-x, merged data 135, and compressed data 136. However, as depicted, the assembly data 131 may be stored within the capture assembly 111, in addition to or in lieu of being stored within the storage 160.

In executing a sequence of instructions of the control routine 140, the processor circuit 150 is caused to await a trigger signal conveying a command to the capture device 100 to operate the image sensors 113a-x substantially in unison to capture multiple images, each of a different portion of a common scene. The trigger signal may be received from the controls 120 and represent direct operation of the controls by an operator of the capture device 100, or the trigger signal may be received from another computing device (not shown), possibly via the network 999. Upon receipt of the trigger signal, the processor circuit 150 does so operate the image sensors 113a-x of the capture assembly 111, and receives signals from each of the image sensors 113a-x conveying the images that each has captured. The processor circuit 150 stores the images received from each of the image sensors 113a-x in the storage 160 as corresponding ones of the captured data 133a-x.

The capture assembly 111 incorporates image sensors 113a through 113x (“x” indicating the possibility of there being a total of two or more image sensors), each of which is paired with a corresponding one of optics 114a-x. Each of the image sensors may be based on any of a variety of technologies for capturing an image of a scene, including and not limited to charge-coupled device (CCD) semiconductor technology. Each of the optics 114a-x is made up of one or more lenses, mirror, prisms, shutters, filters, etc. employed to convey images of a scene to and at least partly define the field of view of corresponding ones of the image sensors 113a-x. The image sensors 113a-x and the optics 114a-x (whatever their quantity) are positioned and oriented relative to each other in a manner intended to provide each image sensor and optics pair with a field of view that overlaps field(s) of view of one or more of the other image sensor and optics pairs.

In each pair of one of the image sensors 113a-x and its corresponding one of the optics 114a-x, both the image sensor and optics in that pair play a role in defining the width of the field of view from which the image sensor captures images. Thus, differences in the widths of the fields of view for each such pair within the capture assembly 111 may be at least partly defined through the use of different types or models of image sensor from one such pair to the next. However, it is envisioned that all of the image sensors 113a-x within the capture assembly 111 will be of the same type and/or model, possibly of the same manufacturing batch and/or possibly fabricated on a common semiconductor die, to aid in achieving relatively similar colorimetry across all of them, and that the differences in widths of each of the fields of view are effected through the use of differing types and/or configurations of optical components of each of the optics 114a-x. Among the envisioned differences among the optics 114a-x may be the use of differing lenses and/or curved reflective surfaces to achieve differing degrees of magnification, defining differing focal lengths, and defining differing widths among the different fields of view.

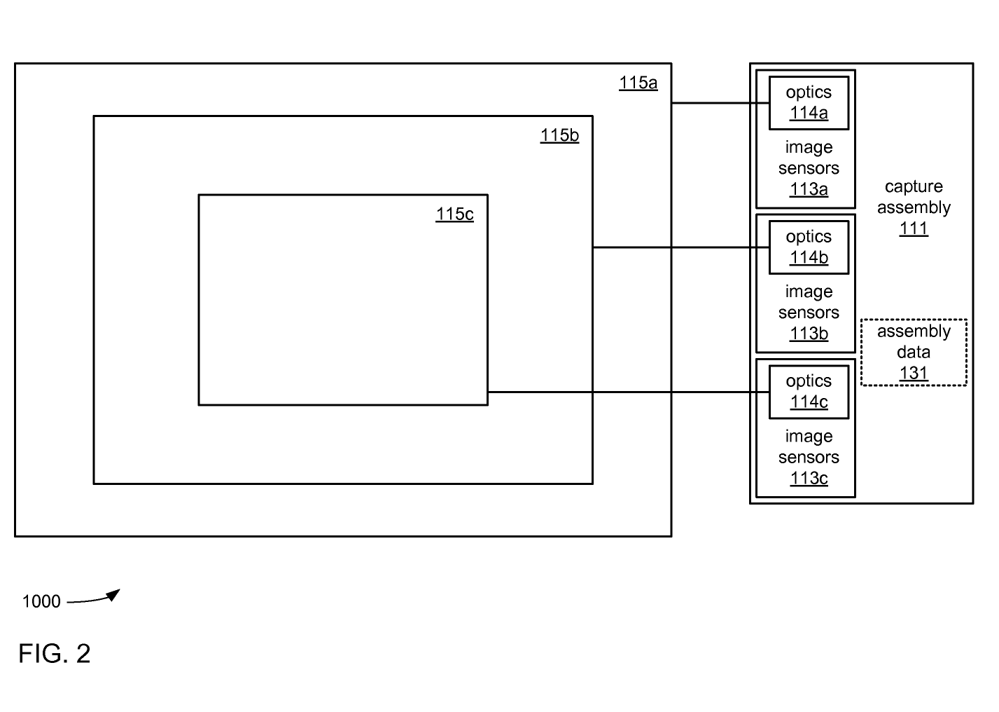

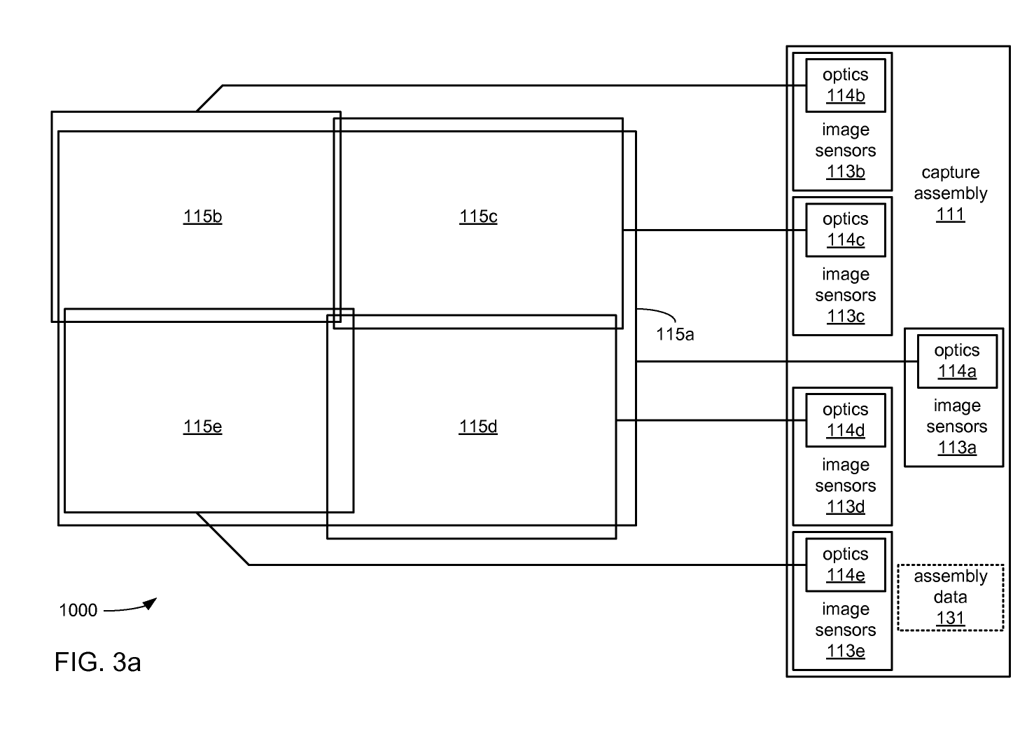

FIG. 2 depicts one example implementation of the capture assembly 111, and FIGS. 3a and 3b depict another example implementation of the capture assembly 111. These figures also depict the manner in which the fields of view associated with of the each image sensors in each implementation overlap. Turning to FIG. 2, the depicted implementation of the capture assembly 111 includes three of the image sensors 113a through 113c, each of which is paired to a corresponding one of the optics 114a through 114c. As depicted, the field of view 115a of the image sensor 113a is the widest, the field of view 115b of the image sensor 113b is somewhat narrower, and the field of view 115c of the image sensor 113c is the narrowest. As also depicted, the three fields of view 115a-c are arranged to overlap in a substantially concentric manner. Thus, where the image sensors 113a-c are operated substantially in unison to capture their respective portions of a common scene, the image captured by the image sensor 113c will be a magnified portion of the image captured by the image sensor 113b, which in turn, will be a magnified portion of the image captured by the image sensor 113a. As a result, and presuming that all three of the sensors 113a-c capture images with the same resolution, the portion of the image captured by the image sensor 113a that is overlapped by the image captured by the image sensor 113b will have been captured at a higher resolution (e.g., with greater pixel density) by the image sensor 113b. This is due to the narrower field of view of the image sensor 113b being entirely devoted to capturing an image only within that overlapped portion such that all of the pixels of the image captured by the image sensor 113b are devoted to doing so, while the wider field of view of the image sensor 113a results in only a subset of the pixels of the image captured by the image sensor 113a being devoted to that same overlapped portion. Correspondingly, the portion of the image captured by the image sensor 113b that is overlapped by the image captured by the image sensor 113c will have been captured at a higher resolution by the image sensor 113c. Thus, upon viewing of the image captured by the image sensor 113a, the images captured by the image sensors 113b and 113c may be used to provide a better implementation of “zooming in” where the area that is zoomed into is towards the center of the image captured by the image sensor 113a, since the images captured by the image sensors 113b and 113c provide higher densities of pixels that provide more detail where each overlaps the image captured by the image sensor 113a.

Turning to FIGS. 3a-b, the depicted implementation of the capture assembly 111 includes five of the image sensors 113a through 113e, each of which is paired to a corresponding one of the optics 114a through 114e. As depicted, the field of view 115a of the image sensor 113a is the widest, and the fields of view 115b-e of the image sensors 113b-e, respectively, are all narrower. As also depicted, the four fields of view 115b-e are each arranged to overlap a different corner of field of view 115a. Thus, where the image sensors 113a-e are operated substantially in unison to capture their respective portions of a common scene, the images captured by the image sensors 113b-e will each be a magnified corner portion of the image captured by the image sensor 113a. As a result, the portions of the image captured by the image sensor 113a that are overlapped by any of the images captured by the image sensors 113b-e will have been captured at a higher resolution by one of the image sensors 113b-e. Given, as depicted, that the images captured by the image sensors 113b-e, together, overlap nearly all of the image captured by the image sensor 113a, one or more of the images captured by the image sensors 113b-e may be used to provide a better implementation of “zooming in” at nearly any location within the image captured by the image sensor 113a upon viewing the image captured by the image sensor 113a.

It should be noted that FIGS. 2 and 3a-b depict but two of many possible implementations of the capture assembly 111 in which any possible number of image sensors and optics may be employed to achieve any of a wide variety of possible combinations of fields of view. However, FIGS. 2 and 3a-b, despite depicting very different configurations of image sensors and optics resulting in very different overlaps in fields of view, both depict examples of the field of view 115a (the widest field of view) as substantially overlapped by the other fields of view 115b-c and 115b-e, respectively. In both, this substantial overlap in fields of view is such that the majority (more than half) of the narrower fields of view 115b-c and 115b-e overlapped the widest field of view 115a.

FIG. 3a also depicts how variances in manufacturing processes that may be employed in creating the capture assembly 111 may result in some degree of imprecision in the relative positions of the fields of view 115a-e. Without the use of a high degree of precision that may be deemed cost prohibitive, it is likely that the edges of the fields of view 115b-e will not perfectly align so as to avoid either gaps or overlapping therebetween. Similarly, without the use of such precision, it is likely that the fields of view 115b-e, combined as depicted, will not perfectly overlap the field of view 115a. It may, therefore, be deemed desirable to adopt such practices as causing the fields of view 115b-e to overlap slightly where they are adjacent to each other to avoid the creation of gaps therebetween.

Given this likelihood of some degree of imprecision, the capture assembly 111 and/or the storage 160 may store the assembly data 131 in which various characteristics of the image sensors 113a-x (e.g., resolution, characterization of response to light levels, etc.), the optics 114a-x (e.g., specified focal length and/or magnification, implemented with lenses and/or mirrors, characterization of response to temperature, etc.) and/or their relative positioning/orientation as assembled within the capture assembly (e.g., distances between optic centers, etc.) as an aid to efforts to properly align the different images captured by the each of the image sensors 113a-x as part of either visually presenting those captured images or merging them into a single merged image.

At least some of the information within the assembly data 131 may be derived from a calibration procedure in which the image sensors 113a-x are employed to capture images of a test pattern following assembly of the capture assembly 111. By way of example, and turning more specifically to FIG. 3b depicting semiconductor-based variants of the image sensors 113a-e installed on a printed circuitboard (possibly along with a storage component storing the assembly data 131), despite the high degree of precision with which such a printed circuitboard (PCB) assembly is made, there is still likely to be imprecision with regard to the alignment of directions of orientation of each of the image sensors 113a-e and their accompanying optics 114a-e, respectively. Through the use of various algorithms to align what is captured in the different fields of view of each of the image sensors 113a-x, parameters specifying the relative positions of those fields of view are derived and used to derive updates to at least a portion of the assembly data 131. Such calibration may be done at the time of manufacture of the capture assembly 111 and/or of the capture device 100. Alternatively or additionally, such calibration may be done at subsequent times, possibly as a maintenance procedure performed over time as aging of components and/or environmental factors may alter the relative positions of the image sensors 113a-x and/or the optics 114a-x.

Following the capturing of images via the capture assembly 111, the processor circuit 150 may be caused to store, distribute and/or visually present the captured images in any of a variety of ways. In some embodiments, the processor circuit 150 is caused to operate the interface 190 to simply transmit the captured data 133a-x directly to another computing device (e.g., the viewing device 300). In so doing, the processor circuit 150 may also transmit the assembly data 131 to better enable that other computing device to derive alignment data indicating the relative positions at which the fields of view of each of the captured images overlap. Such alignment data may then be used by that other computing device in visually presenting the captured images on its display and/or merging them into a single merged image. Further, the processor circuit 150 may be caused to compress the captured data 133a-x and/or the assembly data 131 before transmitting them.

In other embodiments, following the capturing of images, the processor circuit 150 may be caused to itself derive the alignment data 134 indicating the relative positions at which the fields of view of each of the captured images overlap. This may be done as a precursor to the processor circuit 150 visually presenting the captured images on the display 180. Alternatively or additionally, this may be done as a precursor to the processor circuit 150 transmitting the captured data 133a-x to another computing device along with the alignment data 134 to enable that other computing device to visually present the captured images on its display and/or merge the captured images without having to derive the alignment data. Again, the processor circuit 150 may be caused to compress the captured data 133a-x and/or the alignment data 134 before transmitting them.

In visually presenting the images captured by the capture assembly 111 (e.g., the captured images stored as the captured data 133a-x), the alignment data 134 indicates whether a portion of a captured image having a wider field of view is overlapped by another captured image that has a higher density of pixels that would provide greater detail when zooming into that portion. Thus, zooming into a portion of one captured image that is overlapped by another results in effectively switching to viewing at least part of that other captured image to enable viewing of that greater detail.

In merging the captured images of the captured data 133a-x into a single merged image, wherever two or more of the captured images overlap, the pixels of whichever of those overlapping captured images has the highest pixel density are used. The result is a single image made up of two or more portions having different pixel densities with the highest pixel densities available among the captured images being used in each portion. Again, the alignment data 134 indicates where the different captured images overlap, thereby enabling the captured image having the highest pixel density for any given portion of the resulting merged image to be identified.

In still other embodiments, following the capturing of images, the processor circuit 150 may be caused to itself employ the alignment data 134 to merge the captured images overlap stored as the captured data 133a-x into a single merged image that is then stored as the merged data 135. This may be done as a precursor to the processor circuit 150 visually presenting the merged image on the display 180. Alternatively or additionally, this may be done as a precursor to the processor circuit 150 transmitting the merged image to another computing device. Given that the merging of the captured images into a merged image employs the alignment data 134, which may have been derived from the assembly data 131, neither the assembly data 131 or the alignment data 134 need be transmitted to another computing device along with the merged image. As before, the processor circuit 150 may be caused to compress the merged data 135 before transmitting it.

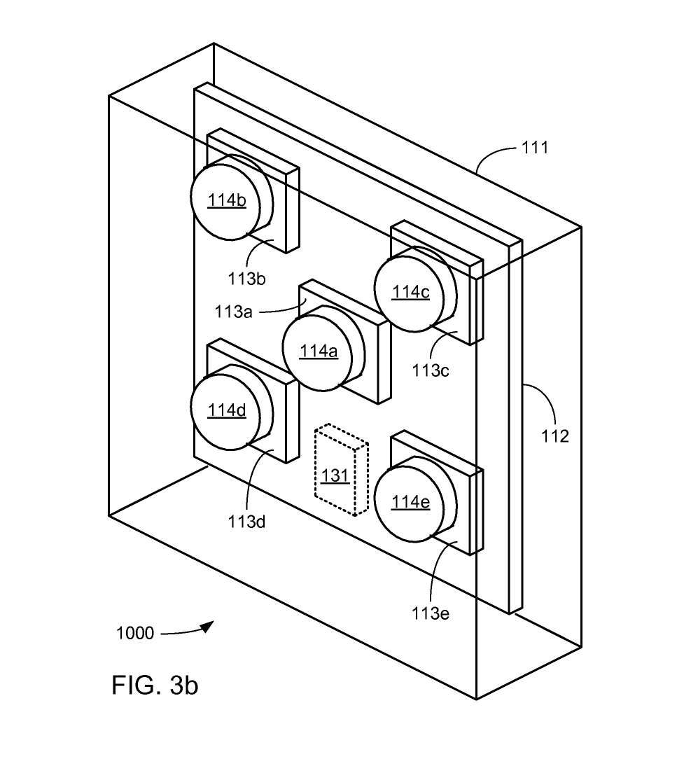

It should be noted that in merging the captured images, where different images of different pixel densities are being combined into a single merged image, issues of misaligned pixels may occur at boundaries where portions from different captured images are joined. FIG. 4 depicts an example of the lower density pixels of a portion of the field of view 115a of either of FIG. 2 or 3 being joined in a misaligned manner to the higher density pixels of a portion of the field of view 115b. With the pixels of one portion partially overlying the pixels of the other portion, merging these two portions as part of merging the captured images of which they are each a part may require per-pixel color averaging, smoothing, blurring, interpolation and/or other image processing techniques to create a smooth transition where they meet. In some embodiments, merging the captured images may entail reprocessing all of the lower density pixels in the resulting merged image to cause all pixels in the merged image to have the same density as the highest density found in any of the captured images that are merged into the merged image. Color averaging to address such misalignment issues may be performed as part of such reprocessing of all lower density pixels.

In various embodiments, the viewing device 300 incorporates one or more of a processor circuit 350, a storage 360, controls 320, a display 380 and an interface 390 coupling the viewing device 300 to the network 999. The storage 360 stores a control routine 340, and copies of one or more of the assembly data 131, the captured data 133a-x, the alignment data 134, the merged data 135 and compressed data 136 received from the capture device 100. In executing a sequence of instructions of the control routine 340, the processor circuit 350 is caused to receive one or more of the assembly data 131, the captured data 133a-x, the alignment data 134, the merged data 135 and compressed data 136. Following such receipt, the processor circuit 350 is caused to visually present on the display 380 one or more images from whichever ones of these pieces of data are received from the capture device 100. The processor circuit 350 is also caused to await the receipt of signals from the controls 320 indicating operation of the controls 320 to convey commands to alter the manner in which the image(s) are visually presented, including and not limited to a command to zoom into a portion of an image.

Following the receipt of data conveying images from the capture device 100, the processor circuit 350 may be caused to visually present them in any of a variety of ways. In some embodiments, where the captured data 133a-x has been received such that the viewing device 300 has been provided with the captured images as captured by the image sensors 113a-x of the capture assembly 111, the processor circuit 350 may simply be caused by the control routine 340 to visually present the captured images on the display 380. Where the captured data 133a-x was received in compressed form as part of the compressed data 136, the processor circuit 350 is caused to decompress the compressed data 136 to retrieve decompressed versions of at least the captured data 133a-x. Where the alignment data 134 has also been received from the capture device 100 (whether compressed as part of the compressed data 136, or not), the processor circuit 350 uses the alignment data 134 to determine whether a captured image with a higher pixel density overlaps a portion of an image with a lower pixel density that is currently displayed at a time when a signal conveying a command to zoom into that portion is received. Where the alignment data 134 indicates that there is such an overlap, then the processor circuit 350 is caused to employ at least a subset of those higher density pixels in providing more detail in displaying that portion. However, where the assembly data 131 is received from the capture device 100 in lieu of the alignment data 134, the processor circuit 350 is caused to derive alignment data from the characteristics indicated in the assembly data 131 of the image sensors 113a-x, the optics 114a-x and/or their relative placement within the capture assembly 111. Further, where neither the assembly data 131 nor the alignment data 134 are received from the capture device 100, the processor circuit 350 is caused to analyze the contents of each of the captured images to determine which ones overlap and at which locations to thereby derive an alignment data.

In other embodiments where the captured data 133a-x has been received either with or without other data regarding alignment, the processor circuit 350 may be caused to merge the captured images represented by each of the captured data 133a-x into a single merged data. In still other embodiments where the merged data 135 has been received such that the viewing device 300 has been provided with a single image of a scene originally captured by the multiple image sensors 113a-x and assembled from the multiple captured images, the processor circuit 350 may simply be caused by the control routine 340 to visually present the captured images on the display 380.

In various embodiments, each of the processor circuits 150 and 350 may include any of a wide variety of commercially available processors, including without limitation, an AMD® Athlon®, Duron® or Opteron® processor; an ARM® application, embedded or secure processor; an IBM® and/or Motorola® DragonBall® or PowerPC® processor; an IBM and/or Sony® Cell processor; or an Intel® Celeron®, Core (2) Duo®, Core (2) Quad®, Core i3®, Core i5®, Core i7®, Atom®, Itanium®, Pentium®, Xeon® or XScale® processor. Further, one or more of these processor circuits may include a multi-core processor (whether the multiple cores coexist on the same or separate dies), and/or a multi-processor architecture of some other variety by which multiple physically separate processors are in some way linked.

In various embodiments, each of the storages 160 and 360 may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, each of the interfaces 190 and 390 employ any of a wide variety of signaling technologies enabling each of computing devices 100 and 300 to be coupled through the network 999 as has been described. Each of these interfaces includes circuitry providing at least some of the requisite functionality to enable such coupling. However, each of these interfaces may also be at least partially implemented with sequences of instructions executed by corresponding ones of the processor circuits 150 and 350 (e.g., to implement a protocol stack or other features). Where one or more portions of the network 999 employs electrically and/or optically conductive cabling, corresponding ones of the interfaces 190 and 390 may employ signaling and/or protocols conforming to any of a variety of industry standards, including without limitation, RS-232C, RS-422, USB, Ethernet (IEEE-802.3) or IEEE-1394. Alternatively or additionally, where one or more portions of the network 999 entails the use of wireless signal transmission, corresponding ones of the interfaces 190 and 390 may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc. It should be noted that although each of the interfaces 190 and 390 are depicted as a single block, one or more of these may include multiple interfaces that may be based on differing signaling technologies. This may be the case especially where one or more of these interfaces couples corresponding ones of the computing devices 100 and 300 to more than one network, each employing differing communications technologies.

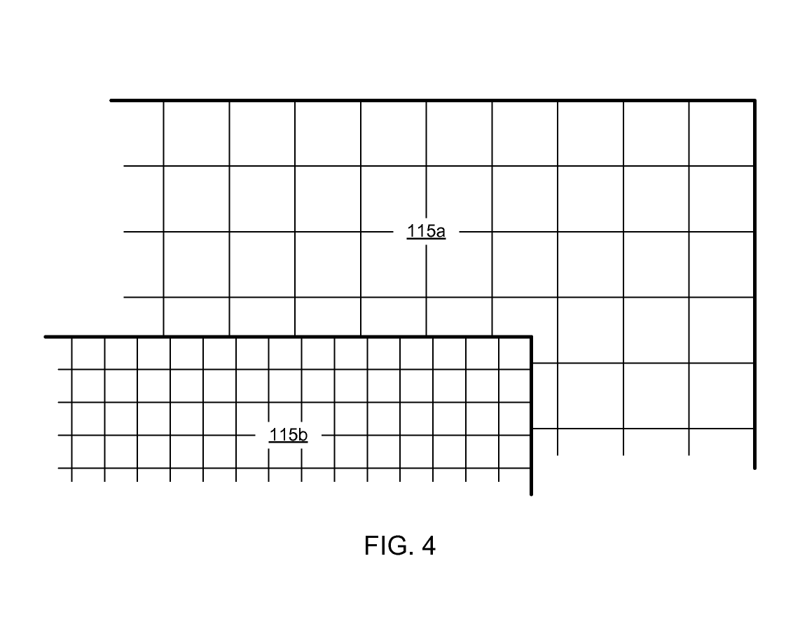

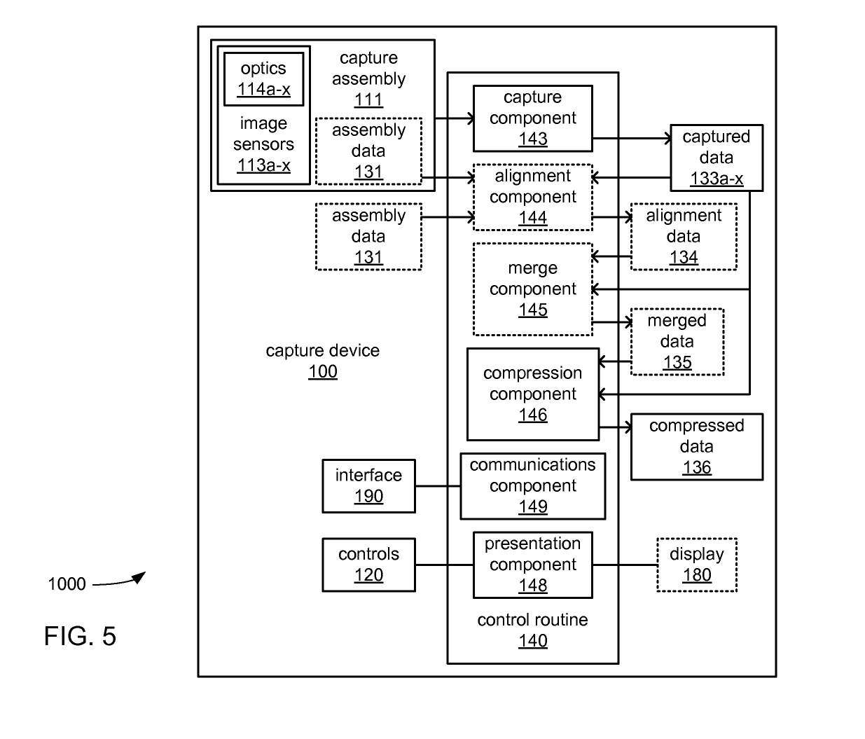

FIGS. 5 and 6, taken together, illustrate block diagrams of portions of the block diagram of FIG. 1 depicted in greater detail. More specifically, aspects of the operating environments of the computing devices 100 and 300 are depicted, in which corresponding ones of the processor circuits 150 and 350 (FIG. 1) are caused by execution of respective control routines 140 and 340 to perform the aforedescribed functions. As will be recognized by those skilled in the art, each of the control routines 140 and 340, including the components of which each is composed, are selected to be operative on whatever type of processor or processors that are selected to implement each of the processor circuits 150 and 350.

In various embodiments, one or more of the control routines 140 and 340 may include a combination of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor circuits 150 and 350, including without limitation, Windows™, OS X™, Linux®, or Android OS™. Where one or more device drivers are included, those device drivers may provide support for any of a variety of other components, whether hardware or software components, that include one or more of the computing devices 100 and 300.

Each of the control routines 140 and 340 includes a communications component 149 and 349, respectively, executable by corresponding ones of the processor circuits 150 and 350 to operate corresponding ones of the interfaces 190 and 390 to transmit and receive signals via the network 999 as has been described. As will be recognized by those skilled in the art, each of these communications components are selected to be operable with whatever type of interface technology is selected to implement each of the corresponding ones of these interfaces.

Turning more specifically to FIG. 5, the control routine 140 includes a capture component 143 to operate the image sensors 113a-x in unison (or at least substantially in unison) in response to receipt of a trigger signal to capture images that each have a different field of view such that each is of a different portion of a common scene. The capture component 143 then stores each of those captured images from each of the image sensors 113a-x as a corresponding one of the captured data 133a-x. As previously discussed, the signal triggering such operation of the image sensors 113a-x may be received from the controls 120 or from another computing device, possibly via the network 999.

In embodiments in which the capture device 100 visually presents the captured images, merges the captured images and/or performs calibration, the control routine 140 includes an alignment component 144. Where the capture device 100 either visually presents the captured images stored as the captured data 133a-x on the display 180 or merges them into the single merged image stored as the merged data 135, the alignment component 144 derives the alignment data 134 from at least the captured data 133a-x. Where the assembly data 131 is stored within the storage 160 and/or within the assembly data 131 such that the assembly data 131 is available, the alignment component 144 may employ the assembly data 131 to generate the alignment data 134, which provides indications of the locations at which each of the captured images overlap. However, where the assembly data 131 is not available, the alignment component 144 employs various algorithms to analyze the content of each of the captured images to identify matching features (what is sometimes referred to as “feature detection”) in order to determine the locations at which they overlap. It may be deemed desirable to provide sufficient information within the assembly data 131 to avoid the need to use feature detection techniques, as such techniques are often computationally demanding.

Where the capture device 100 is occasionally operated to perform calibration to update at least a portion of the assembly data 131, the alignment component 144 employs the different captured images of a test pattern stored as the captured data 133a-x to derive one or more new parameters quantifying characteristics of the image sensors 113a-x, of the optics 114a-x and/or of their relative positioning within the capture assembly 111. The alignment component 144 then accesses the assembly data 131 stored in one or both of the storage 160 and the capture assembly 111 to update it.

The control routine 140 may include a merge component 145 to employ the alignment data 134 derived by the alignment component 144 to combine the captured images stored as the captured data 133a-x into a single merged image. The merge component 145 then stores the resulting merged image as the merged data 135.

The control routine 140 may include a compression component 146 to employ any of a variety of known compression algorithms to compress one or more of the assembly data 131, the captured data 133a-x, the alignment data 134 and the merged data 135 to create the compressed data 136. Exactly which of these pieces of data are subjected to compression and included in the compressed data 136 varies among different possible implementations and/or may depend on the manner in which the capture device 100 is used. The compressed data 136, regardless of what exactly it includes, may be stored in the storage 160 and/or may be transmitted to another computing device for storage or viewing (e.g., the viewing device 300).

In embodiments in which the capture device 100 is employed to visually present the captured images, the control routine 140 includes a presentation component 148 to visually present either the captured data 133a-x directly or the merged data 135. Where the captured data 133a-x is visually presented, it may be deemed desirable to visually present the one of the captured images with the widest field of view by default. Then, if a signal is received indicating operation of the controls 120 to convey a command to the capture device 100 to zoom in on a portion of that captured image, the presentation component 148 employs the alignment data 134 to determine whether there is another captured image among the captured data 133a-x that overlaps that portion to be zoomed into that has a higher pixel density. If such another captured image is identified, then at least some pixels of that other captured image are employed in presenting the zoomed view. If not, then the pixels of the captured image that is currently visually presented are scaled up.

However, where the merged data 135 is visually presented, and a signal is received indicating operation of the controls 120 to convey a command to the capture device 100 to zoom in on a portion of the merged image stored as the merged data 135, the presentation component 148 simply scales up the pixels in that portion of the merged image. Given that the merged image combines all of the higher pixel density captured images within the merged image wherever possible, any higher density pixel information that was originally captured that covers the zoomed in portion will already be present within the merged image, and will present its higher resolution details upon being scaled up in size to become easier to see.

Turning more specifically to FIG. 6, the control routine 340 may include a decompression component 346 to decompress image data and/or other data associated with images that is received by the viewing device 300 in compressed form. As previously discussed, any of the assembly data 131, the captured data 133a-x, the alignment data 134 and/or the merged data 135 may be received within the compressed data 136 that may be provided to the viewing device 300 by the capture device 100.

In embodiments in which the viewing device 300 is meant to visually present the captured data 133a-x without the benefit of also being provided the alignment data 134, the control routine 340 includes an alignment component 344 to enable the viewing device 300 to independently derive such alignment data. Where the assembly data 131 is received from the capture device 100 along with the captured data 133a-x, the alignment component 344 may employ the assembly data 131 to generate an alignment data 334, which provides indications of the locations at which each of the captured images of the captured data 133a-x overlap. Again, deriving alignment data in this manner, rather than by feature detection, is less computationally demanding. However, where the assembly data 131 is not available, the alignment component 344 employs one or more feature detection algorithms to analyze the content of each of the captured images of the captured data 133a-x to determine the locations at which they overlap.

The control routine 340 may include a merge component 345 to employ either the alignment data 134 or 334 (whichever is available) to enable the viewing device 300 to independently combine the captured images stored as the captured data 133a-x into a single merged image. The merge component 345 then stores the resulting merged image as the merged data 335. Creation of a merged image from multiple captured images by the viewing device 300 may be deemed desirable as a technique to enable more compact storage of image data received from other computing devices (e.g., the capture device 100), since redundant lower resolution pixel data is discarded when merging.

The control routine 340 includes a presentation component 348 to visually present either the captured data 133a-x received from the capture device 100 or the merged image either received from the capture device 100 as the merged data 135 or independently created by the viewing device 300 as the merged data 335. Where the captured data 133a-x is visually presented, it may be deemed desirable to visually present the one of the captured images with the widest field of view by default. Then, if a signal is received indicating operation of the controls 320 to convey a command to the viewing device 300 to zoom in on a portion of that captured image, the presentation component 348 employs the alignment data 134 or 334 (whichever is available) to determine whether there is another captured image among the captured data 133a-x that overlaps that portion to be zoomed into that has a higher pixel density. If such another captured image is identified, then at least some pixels of that other captured image are employed in presenting the zoomed view. If not, then the pixels of the captured image that is currently visually presented are scaled up.

However, where the merged data 135 or 335 is visually presented, and a signal is received indicating operation of the controls 320 to convey a command to the viewing device 300 to zoom in on a portion of the merged image, the presentation component 348 simply scales up the pixels in that portion of the merged image. Again, any higher density pixel information that was originally captured that covers the zoomed in portion will already be present within the merged image, and will present its higher resolution details upon being scaled up in size to become easier to see.

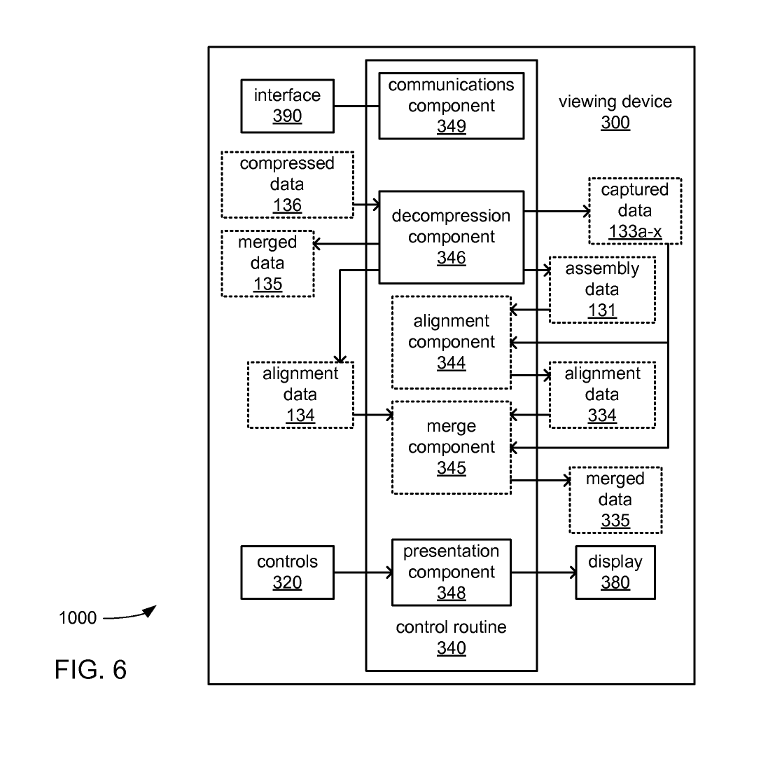

FIG. 7 illustrates one embodiment of a logic flow 2100. The logic flow 2100 may be representative of some or all of the operations executed by one or more embodiments described herein. More specifically, the logic flow 2100 may illustrate operations performed by the processor circuit 150 of the capture device 100 in executing at least the control routine 140.

At 2110, a capture device (e.g., the capture device 100) receives a signal to operate image sensors of a capture assembly (e.g., the image sensors 113a-x of the capture assembly 111) of the capture device in unison (or at least substantially in unison) to capture images of different portions dictated by differing fields of view of a test pattern for calibration. At 2120, the capture device responds to the signal by operating those image sensors to capture those images of the test pattern for calibration.

At 2130, the capture device employs one or more feature detection algorithms to identify locations at which the different captured images of the test pattern overlap to derive updated characteristics of the image sensors, optics associated with the image sensors, relative positions of the image sensors and/or the optics, etc. As previously discussed, such calibration to update such characteristics may be performed on a recurring basis over time to account for changes in those characteristics that may arise from aging of components, responses of the capture assembly to environmental circumstances, etc.

At 2140, the capture device updates at least a portion of an assembly data (e.g., the assembly data 131) that may be stored within the capture assembly itself and/or stored within a storage of the capture device (e.g., the storage 160). As has been previously explained, an initial calibration resulting in an initial set of values for the assembly data may have been performed as the capture assembly was itself manufactured, and therefore, may have been stored within the capture assembly to ensure it would accompany the capture assembly regardless of which capture device into which the capture assembly was installed.

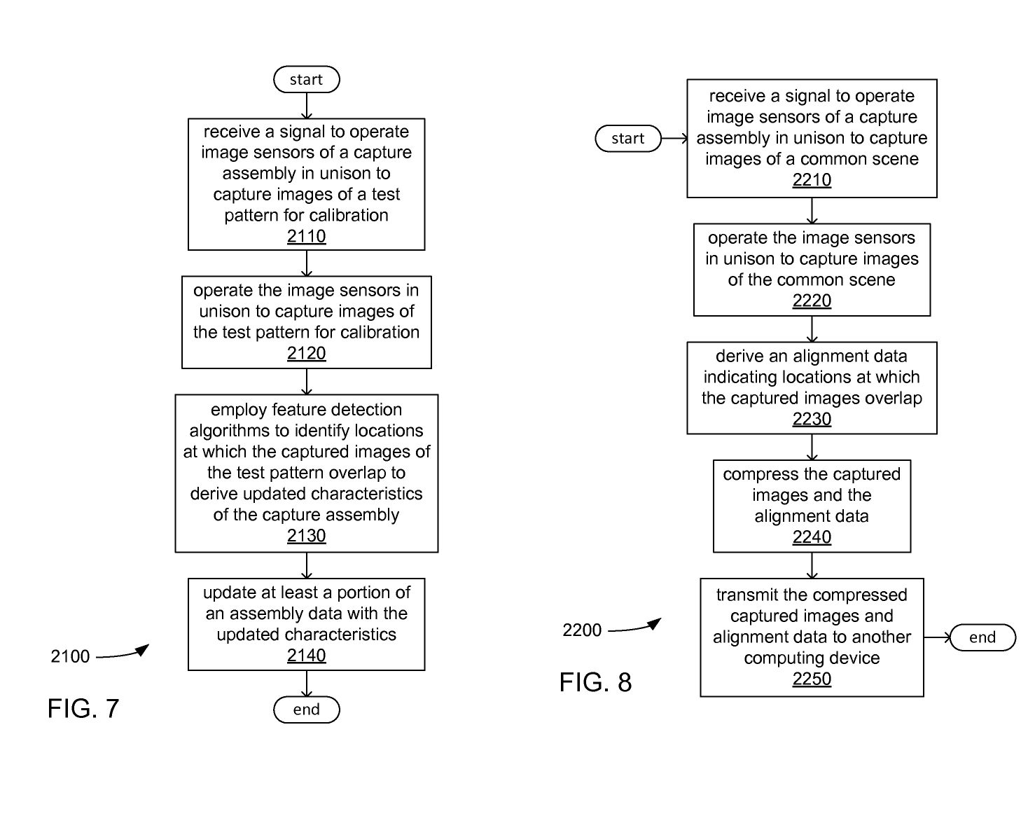

FIG. 8 illustrates one embodiment of a logic flow 2200. The logic flow 2200 may be representative of some or all of the operations executed by one or more embodiments described herein. More specifically, the logic flow 2200 may illustrate operations performed by the processor circuit 150 of the capture device 100 in executing at least the control routine 140.

At 2210, a capture device (e.g., the capture device 100) receives a signal to operate image sensors of a capture assembly (e.g., the image sensors 113a-x of the capture assembly 111) of the capture device in unison to capture images of a common scene. As has been explained, the image sensors 113a-x of the capture assembly 111 are positioned to all capture a portion of a common scene when operated in unison to capture images. At 2220, the capture device responds to the signal by operating those image sensors to capture those images of the common scene.

At 2230, the capture device employs one or more feature detection algorithms or an assembly data (e.g., the assembly data 131) to derive an alignment data indicating locations at which the different captured images of the common scene overlap. As previously discussed, use of data indicating various characteristics of the capture assembly to derive the alignment data may be deemed more desirable since the use of feature detection algorithms is often computationally demanding.

At 2240, the captured images and the alignment data are compressed using any of a variety of known compression algorithms. As has been discussed, such combinations of image-related data may be compressed into a single piece of compressed data (e.g., the compressed data 136). However, the captured images may alternatively be compressed separately from the alignment data, possibly with each one of captured images being compressed separately from the others. At 2250, the compressed captured images and the alignment data are transmitted to another computing device (e.g., the viewing device 300).

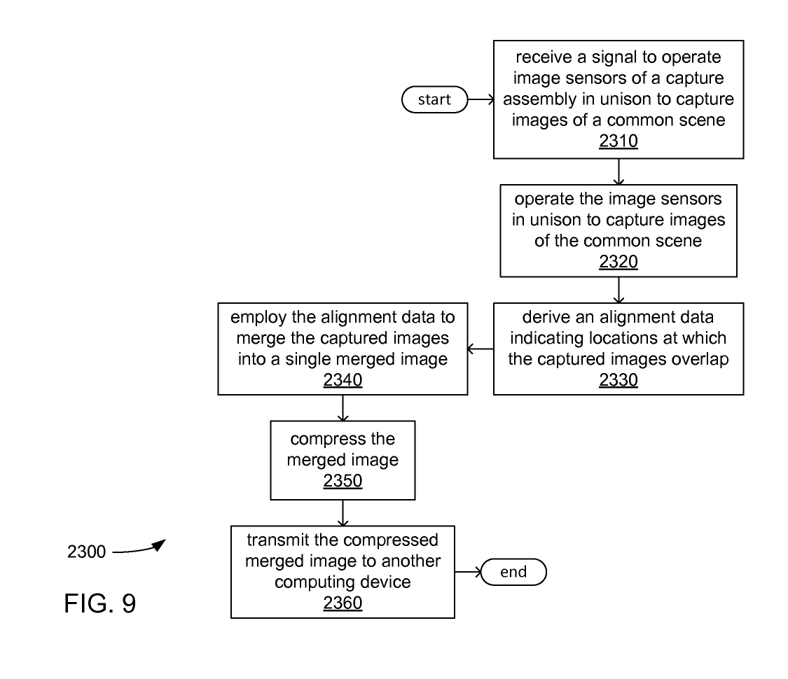

FIG. 9 illustrates one embodiment of a logic flow 2300. The logic flow 2300 may be representative of some or all of the operations executed by one or more embodiments described herein. More specifically, the logic flow 2300 may illustrate operations performed by the processor circuit 150 of the capture device 100 in executing at least the control routine 140.

At 2310, a capture device (e.g., the capture device 100) receives a signal to operate image sensors of a capture assembly (e.g., the image sensors 113a-x of the capture assembly 111) of the capture device in unison to capture images of a common scene. Again, as has been explained, the image sensors 113a-x of the capture assembly 111 are positioned to all capture a portion of a common scene when operated in unison to capture images. At 2320, the capture device responds to the signal by operating those image sensors to capture those images of the common scene.

At 2330, the capture device employs one or more feature detection algorithms or an assembly data (e.g., the assembly data 131) to derive an alignment data indicating locations at which the different captured images of the common scene overlap. At 2340, the alignment data is employed to merge the captured images into a single merged image in which the captured images having the higher pixel densities are used to replace portions made up of pixels at lower pixel densities wherever possible such that the resulting merged image incorporates as much of the detail captured among the captured images as possible.

At 2350, the merged image is compressed using any of a variety of known compression algorithms. At 2360, the compressed merged image is transmitted to another computing device (e.g., the viewing device 300).

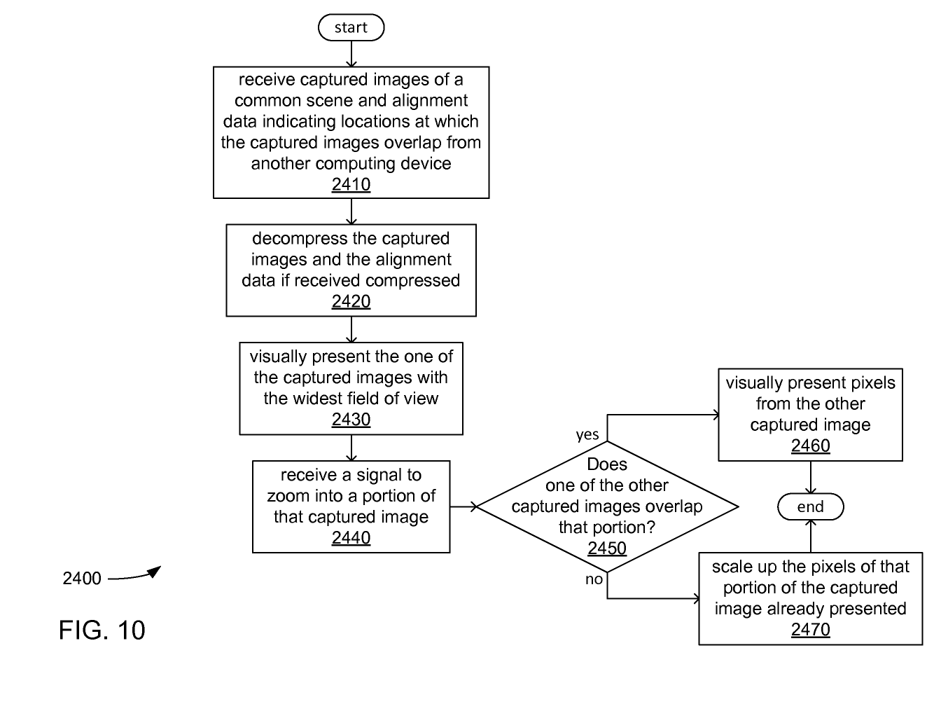

FIG. 10 illustrates one embodiment of a logic flow 2400. The logic flow 2400 may be representative of some or all of the operations executed by one or more embodiments described herein. More specifically, the logic flow 2400 may illustrate operations performed by the processor circuit 350 of the viewing device 300 in executing at least the control routine 340.

At 2410, a viewing device (e.g., the viewing device 300) receives from another computing device (e.g., the capture device 100) captured images of a common scene and alignment data indicating locations in the captured images at which the captured images overlap. At 2420, the captured images and/or the alignment data are decompressed, if either was received compressed.

At 2430, the one of the captured images with the widest field of view is visually presented on a display of the viewing device (e.g., the display 380). As has been discussed, the viewing device 300 incorporates both the display 380 and controls 320 enabling an interactive viewing of imagery. At 2440, the viewing device receives a signal conveying a command to the viewing device to zoom into a portion of that captured image currently visually presented.

At 2450, a check is made as to whether there is another captured image among the captured images of the common scene received from the other computing device that has a higher pixel density and that overlaps that portion of the currently visually presented captured image. If there is, then at least some of the pixels of that other captured image are visually presented on the display as part of zooming into that portion at 2460, thereby visually presenting more detail. If not, then the pixels in that portion of the captured image currently visually presented are scaled up.

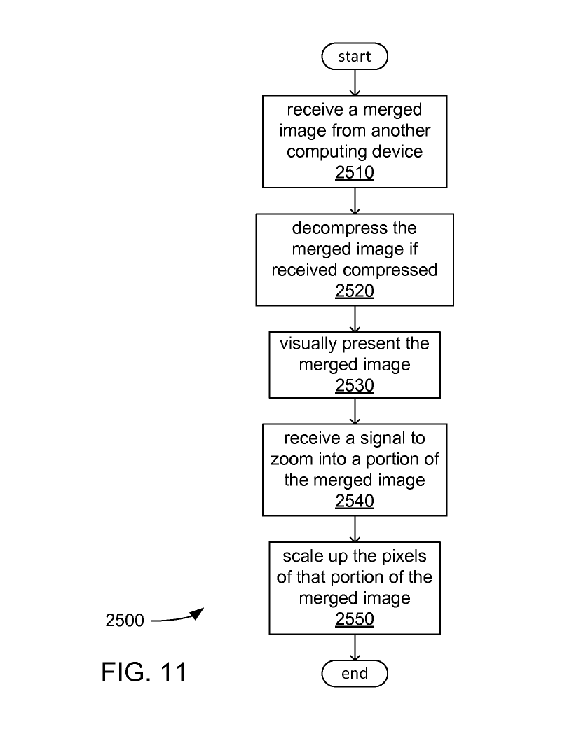

FIG. 11 illustrates one embodiment of a logic flow 2500. The logic flow 2500 may be representative of some or all of the operations executed by one or more embodiments described herein. More specifically, the logic flow 2500 may illustrate operations performed by the processor circuit 350 of the viewing device 300 in executing at least the control routine 340.

At 2510, a viewing device (e.g., the viewing device 300) receives from another computing device (e.g., the capture device 100) a merged image formed from captured images of a common scene. At 2520, the merged image is decompressed, if it was received compressed.

At 2530, the merged image is visually presented on a display of the viewing device (e.g. the display 380). As has been discussed, the viewing device 300 incorporates both the display 380 and controls 320 enabling an interactive viewing of imagery.

At 2540, the viewing device receives a signal conveying a command to the viewing device to zoom into a portion of the merged image. At 2550, in response to the command, the pixels in that portion of the merged image are scaled up.

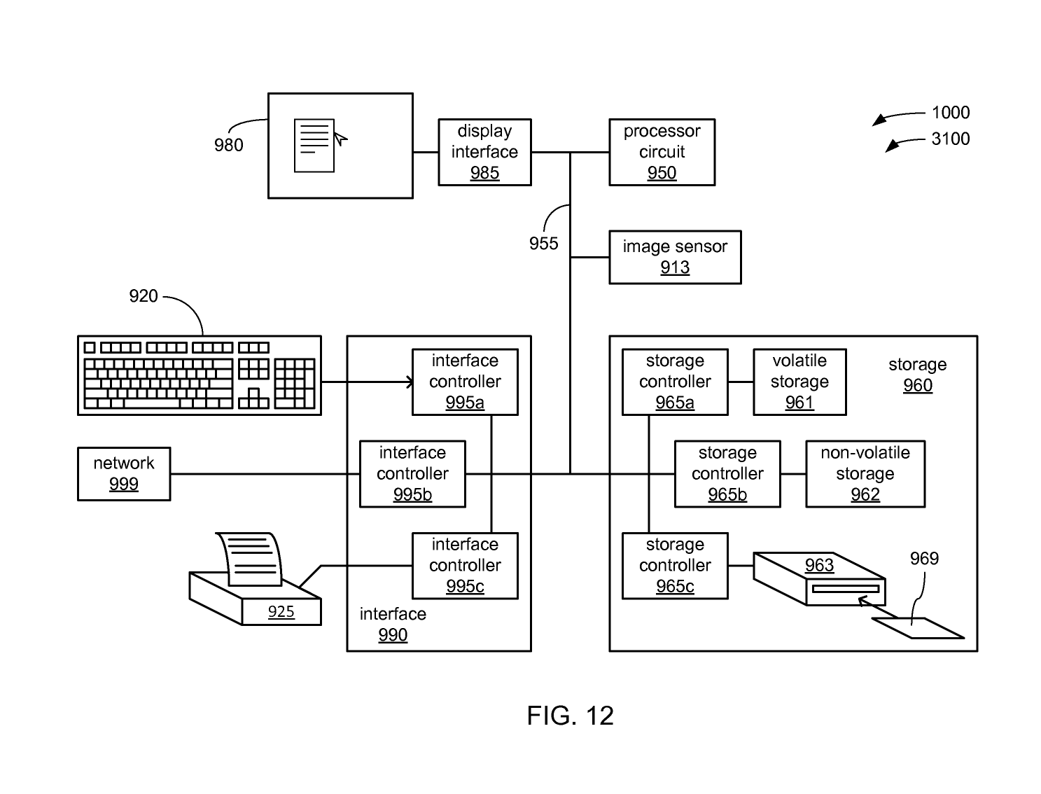

FIG. 12 illustrates an embodiment of an exemplary processing architecture 3100 suitable for implementing various embodiments as previously described. More specifically, the processing architecture 3100 (or variants thereof) may be implemented as part of one or more of the computing devices 100 and 300. It should be noted that components of the processing architecture 3100 are given reference numbers in which the last two digits correspond to the last two digits of reference numbers of components earlier depicted and described as part of each of the computing devices 100 and 300. This is done as an aid to correlating such components of whichever ones of the computing devices 100 and 300 may employ this exemplary processing architecture in various embodiments.

The processing architecture 3100 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor circuit, the processor circuit itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. Each message may be a signal or a plurality of signals transmitted either serially or substantially in parallel.

As depicted, in implementing the processing architecture 3100, a computing device incorporates at least a processor circuit 950, a storage 960, an interface 990 to other devices, and coupling 955. As will be explained, depending on various aspects of a computing device implementing the processing architecture 3100, including its intended use and/or conditions of use, such a computing device may further incorporate additional components, such as without limitation, a controller 900.

The coupling 955 incorporates one or more buses, point-to-point interconnects, transceivers, buffers, crosspoint switches, and/or other conductors and/or logic that communicatively couples at least the processor circuit 950 to the storage 960. The coupling 955 may further couple the processor circuit 950 to one or more of the interface 990 and the display interface 985 (depending on which of these and/or other components are also present). With the processor circuit 950 being so coupled by couplings 955, the processor circuit 950 is able to perform the various ones of the tasks described at length, above, for whichever ones of the computing devices 100 and 300 implement the processing architecture 3100. The coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor circuit 950 (corresponding to one or more of the processor circuits 150 and 350) may include any of a wide variety of commercially available processors, employing any of a wide variety of technologies and implemented with one or more cores physically combined in any of a number of ways.

As previously discussed, the storage 960 (corresponding to one or more of the storages 160 and 360) may include one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 as possibly comprising multiple distinct types of storage is in recognition of the commonplace use of more than one type of storage device in computing devices in which one type provides relatively rapid reading and writing capabilities enabling more rapid manipulation of data by the processor circuit 950 (but possibly using a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of removable machine-readable storage media 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage media 969.

One or the other of the volatile storage 961 or the non-volatile storage 962 may include an article of manufacture in the form of a machine-readable storage media on which a routine comprising a sequence of instructions executable by the processor circuit 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to removable storage media such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine comprising a sequence of instructions to be executed by the processor circuit 950 may initially be stored on the machine-readable storage media 969, and the removable media storage 963 may be subsequently employed in copying that routine to the non-volatile storage 962 for longer term storage not requiring the continuing presence of the machine-readable storage media 969 and/or the volatile storage 961 to enable more rapid access by the processor circuit 950 as that routine is executed.

As previously discussed, the interface 990 (corresponding to one or more of the interfaces 190 and 390) may employ any of a variety of signaling technologies corresponding to any of a variety of communications technologies that may be employed to communicatively couple a computing device to one or more other devices. Again, one or both of various forms of wired or wireless signaling may be employed to enable the processor circuit 950 to interact with input/output devices (e.g., the depicted example keyboard 920 or printer 925) and/or other computing devices, possibly through a network (e.g., the network 999) or an interconnected set of networks. In recognition of the often greatly different character of multiple types of signaling and/or protocols that must often be supported by any one computing device, the interface 990 is depicted as comprising multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network comprising one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3100 may also incorporate the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

Further, a computing device implementing the processing architecture 3100 may also incorporate one or more of an image sensor 913 to capture images of scenery within its field of view. The image sensor 913 may be based on any of a wide variety of technologies, including semiconductor technologies implementing a multidimensional array of light sensitive elements operated in cooperation to provide a raster-scanned captured image.

More generally, the various elements of the computing devices 100 and 300 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

An example of a device includes a first image sensor to capture a first image of a scene with a first field of view, a second image sensor to capture a second image of the scene with a second field of view that is narrower than and substantially overlaps the first field of view, a processor circuit, and a storage communicatively coupled to the processor circuit to store instructions. When executed by the processor circuit, the instructions cause the processor circuit to operate the first image sensor to capture a first image of the scene, and operate the second image sensor substantially in unison with the first image sensor to capture a second image of the scene that overlaps the first image.

The above example of a device in which the processor circuit is to derive a position at which the second image overlaps the first image.

Either of the above examples of a device in which the processor is to employ feature detection to derive the position.

Any of the above examples of a device in which the processor circuit is to derive an updated characteristic comprising a characteristic of at least one of the first image sensor, the second image sensor, a first optics paired with the first image sensor, a second optics paired with the second image sensor, and a relative position of two or more of the first image sensor, the second image sensor, the first optics and the second optics; and store an indication of the updated characteristic as a portion of an assembly data.

Any of the above examples of a device in which the processor circuit is to employ an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

Any of the above examples of a device in which the processor circuit is to transmit the first image, the second image and an indication of the position at which the second image overlaps the first image to a computing device via a network.

Any of the above examples of a device in which the processor circuit is to merge the first image and the second image to create a merged image, the merged image comprising the first image in which pixels of the first image at the position at which the second image overlaps the first image are replaced by pixels of the second image.

Any of the above examples of a device in which the pixels of the second image having a higher pixel density than the pixels of the first image.

Any of the above examples of a device in which the device includes a display, and the processor circuit is to visually present the merged image on the display.

Any of the above examples of a device in which the device includes a first optics paired with the first image sensor to define the first field of view; and a second optics paired with the second image sensor to define the second field of view, the first and second image sensors comprising image sensors of a same type or model.

An example of a computer-implemented method includes deriving a position at which a first image of a scene having a first field of view is overlapped by a second image of the scene having a second field of view that is narrower than the first field of view and substantially overlaps the first field of view; and merging the first and second images by replacing pixels of the first image at the position at which the second image overlaps the first image with pixels of the second image.

The above example of a computer-implemented method in which the pixels of the second image having a higher pixel density than the pixels of the first image.

Either of the above examples of a computer-implemented method in which the method includes operating the first image sensor to capture the first image, and operating the second image sensor substantially in unison with the first image sensor to capture the second image.

Any of the above examples of a computer-implemented method in which the method includes employing an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

Any of the above examples of computer-implemented method in which the method includes employing feature detection to derive the position.

Any of the above examples of computer-implemented method in which the method includes visually presenting the merged image on a display, receiving a signal that conveys a command to zoom into a portion of the merged image, and scaling up pixels of the portion of the merged image based on receipt of the signal.

Another example of a device includes a processor circuit, and a storage communicatively coupled to the processor circuit to store instructions. When executed by the processor circuit the instructions cause the processor circuit to visually present a first image of a scene on a display; receive a signal that conveys a command to zoom into a portion of the first image; determine whether a second image of the scene that has a narrower field of view than the first image and that substantially overlaps the first image overlaps the portion; and visually present at least a subset of pixels of the second image on the display based on receipt of the signal and based on the second image overlapping the portion.

The above example of a device in which the processor circuit is caused to scale up pixels of the portion of the first image based on receipt of the signal and based on the second image not overlapping the portion.

Either of the above examples of a device in which the device includes the display.

Any of the above examples of a device in which the device includes manually operable controls, the signal received from the controls and indicative of operation of the controls to convey the command to zoom into the portion.

Any of the above examples of a device in which the device includes a first image sensor having a first field of view and a second image sensor having a second field of view that is narrower than the first field of view and substantially overlaps the first field of view. The processor is caused to operate the first image sensor to capture the first image, and operate the second image sensor substantially in unison with the first image sensor to capture the second image.

Any of the above examples of a device in which the processor circuit is caused to derive a position at which the second image overlaps the first image.

Any of the above examples of a device in which the processor circuit is caused to employ feature detection to derive the position.

Any of the above examples of a device in which the processor circuit is caused to merge the first image and the second image to create a merged image, the merged image comprising the first image in which pixels of the first image at the position at which the second image overlaps the first image are replaced by pixels of the second image.

Any of the above examples of a device in which the processor circuit is caused to visually present the merged image on the display, receive another signal that conveys a command to zoom into a portion of the merged image, and scale up pixels of the portion of the merged image based on receipt of the other signal.

An example of at least one machine-readable storage medium includes instructions that when executed by a computing device, cause the computing device to derive a position at which a first image of a scene having a first field of view is overlapped by a second image of the scene having a second field of view that is narrower than the first field of view and substantially overlaps the first field of view, and merge the first and second images by replacing pixels of the first image at the position at which the second image overlaps the first image with pixels of the second image.

The above example of at least one machine-readable storage medium in which the computing device is caused to operate the first image sensor to capture the first image, and operate the second image sensor substantially in unison with the first image sensor to capture the second image.

Either of the above examples of at least one machine-readable storage medium in which the computing device is caused to employ an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

Any of the above examples of at least one machine-readable storage medium in which the computing device is caused to employ feature detection to derive the position.

Any of the above examples of at least one machine-readable storage medium in which the computing device is caused to visually present the merged image on a display, receive a signal that conveys a command to zoom into a portion of the merged image, and scale up pixels of the portion of the merged image based on receipt of the signal.

1. A device comprising:
a first image sensor to capture a first image of a scene with a first field of view;
a second image sensor to capture a second image of the scene with a second field of view that is narrower than and substantially overlaps the first field of view;
a processor circuit; and
a storage communicatively coupled to the processor circuit to store instructions that when executed by the processor circuit cause the processor circuit to:
cause the first image sensor to capture a first image of the scene; and
cause the second image sensor substantially in unison with the first image sensor to capture a second image of the scene that overlaps the first image.

2. The device of claim 1, the processor circuit to derive a position at which the second image overlaps the first image.

3. The device of claim 2, the processor circuit to employ feature detection to derive the position.

4. The device of claim 3, the processor circuit to:
derive an updated characteristic comprising a characteristic of at least one of the first image sensor, the second image sensor, a first optics paired with the first image sensor, a second optics paired with the second image sensor, and a relative position of two or more of the first image sensor, the second image sensor, the first optics and the second optics; and
store an indication of the updated characteristic as a portion of an assembly data.

5. The device of claim 2, the processor circuit to employ an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

6. The device of claim 2, the processor circuit to transmit the first image, the second image and an indication of the position at which the second image overlaps the first image to a computing device via a network.

7. The device of claim 1, the processor circuit to merge the first image and the second image to create a merged image, the merged image comprising the first image in which pixels of the first image at the position at which the second image overlaps the first image are replaced by pixels of the second image.

8. The device of claim 7, the pixels of the second image having a higher pixel density than the pixels of the first image.

9. The device of claim 7, comprising a display, and the processor circuit to visually present the merged image on the display.

10. The device of claim 1, comprising:
a first optics paired with the first image sensor to define the first field of view; and
a second optics paired with the second image sensor to define the second field of view, the first and second image sensors comprising image sensors of a same type or model.

11. A computer-implemented method comprising:
deriving a position at which a first image of a scene having a first field of view is overlapped by a second image of the scene having a second field of view that is narrower than the first field of view and substantially overlaps the first field of view; and
merging the first and second images by replacing pixels of the first image at the position at which the second image overlaps the first image with pixels of the second image.

12. The computer-implemented method of claim 11, the pixels of the second image having a higher pixel density than the pixels of the first image.

13. The computer-implemented method of claim 11, comprising:
operating the first image sensor to capture the first image; and
operating the second image sensor substantially in unison with the first image sensor to capture the second image.

14. The computer-implemented method of claim 13, comprising employing an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

15. The computer-implemented method of claim 11, comprising employing feature detection to derive the position.

16. The computer-implemented method of claim 11, comprising:
visually presenting the merged image on a display;
receiving a signal that conveys a command to zoom into a portion of the merged image; and
scaling up pixels of the portion of the merged image based on receipt of the signal.

17. A device comprising:
a processor circuit; and
a storage communicatively coupled to the processor circuit to store instructions that when executed by the processor circuit cause the processor circuit to:
visually present a first image of a scene on a display;
receive a signal that conveys a command to zoom into a portion of the first image;
determine whether a second image of the scene that has a narrower field of view than the first image and that substantially overlaps the first image overlaps the portion; and
visually present at least a subset of pixels of the second image on the display based on receipt of the signal and based on the second image overlapping the portion.

18. The device of claim 17, the processor circuit caused to scale up pixels of the portion of the first image based on receipt of the signal and based on the second image not overlapping the portion.

19. The device of claim 17, comprising the display.

20. The device of claim 17, comprising manually operable controls, the signal received from the controls and indicative of operation of the controls to convey the command to zoom into the portion.

21. The device of claim 17, comprising a first image sensor having a first field of view and a second image sensor having a second field of view that is narrower than the first field of view and substantially overlaps the first field of view, the processor caused to:
operate the first image sensor to capture the first image; and
operate the second image sensor substantially in unison with the first image sensor to capture the second image.

22. The device of claim 17, the processor circuit caused to derive a position at which the second image overlaps the first image.

23. The device of claim 22, the processor circuit caused to employ feature detection to derive the position.

24. The device of claim 22, the processor circuit caused to merge the first image and the second image to create a merged image, the merged image comprising the first image in which pixels of the first image at the position at which the second image overlaps the first image are replaced by pixels of the second image.

25. The device of claim 24, the processor circuit caused to:
visually present the merged image on the display;
receive another signal that conveys a command to zoom into a portion of the merged image; and
scale up pixels of the portion of the merged image based on receipt of the other signal.

26. At least one machine-readable storage medium comprising instructions that when executed by a computing device, cause the computing device to:
derive a position at which a first image of a scene having a first field of view is overlapped by a second image of the scene having a second field of view that is narrower than the first field of view and substantially overlaps the first field of view; and
merge the first and second images by replacing pixels of the first image at the position at which the second image overlaps the first image with pixels of the second image.

27. The at least one machine-readable storage medium of claim 26, the computing device caused to:
operate the first image sensor to capture the first image; and
operate the second image sensor substantially in unison with the first image sensor to capture the second image.

28. The at least one machine-readable storage medium of claim 27, the computing device caused to employ an assembly data to derive the position, the assembly data comprising an indication of a characteristic of at least one of the first image sensor, the second image sensor, a first optics paired with the first image sensor, a second optics paired with the second image sensor, and a relative position of two or more of the first image sensor, the second image sensor, the first optics and the second optics.

29. The at least one machine-readable storage medium of claim 26, the computing device caused to employ feature detection to derive the position.

30. The at least one machine-readable storage medium of claim 26, the computing device caused to:
visually present the merged image on a display;
receive a signal that conveys a command to zoom into a portion of the merged image; and
scale up pixels of the portion of the merged image based on receipt of the signal.
